(19) United States
(12) Patent Application Publication
(10) Pub. No.: US 2018/0372619 A1
(43) Pub. Date: Dec. 27, 2018

(54) CELL FOR TRANSMISSION AND ABSORBANCE TESTING

(71) Applicant: International Crystal Laboratories, Garfield, NJ (US)

(72) Inventor: Steven Hanst, Garfield, NJ (US)

(73) Assignee: International Crystal Laboratories, Garfield, NJ (US)

(21) Appl. No.: 15/842,440

(22) Filed: Dec. 14, 2017

Related U.S. Application Data
(60) Provisional application No. 62/432,777, filed on Dec. 12, 2016.

(51) Int. Cl. G01N 21/15; G01N 21/65; G01N 21/03; G01N 21/33; G01N 21/35

(52) U.S. Cl. CPC G01N 21/15; G01N 21/65; G01N 21/0303; G01N 2021/651; G01N 21/35; G01N 2021/0389; G01N 21/33

(57) ABSTRACT

A cell for transmission and absorbance testing by means of infrared, UV/VIS or Raman spectroscopy is provided. The cell comprises a unique combination of seals and window configurations which allow use of inert fluoropolymer and/or elastomer seals instead of the convention sealing means used in spectroscopic sampling cells currently is use, particularly lead seals amalgamated with mercury which are not useable under RoHS rules particularly the EU RoHS directive, which is Directive 2011/65/EU of the European Parliament. The seal configuration also permits innovative cell configurations for UV/VIS spectroscopy and Raman which usually employ cuvettes comprised of glass or fused silica with fused seals or melted frit seals.

### BACKGROUND OF THE INVENTION

A short path absorption cell is used in many different forms for a wide variety of applications in industry and science where analysis of liquids and liquid mixtures is performed by means of spectroscopic analysis. In a very common configuration, a sealed or demountable liquid sample cell comprises a pair of windows parallel to each other with a spacer separating the windows to allow the sample to flow into the space between the windows created by spacer means. Typically, one of the windows has holes to enable inward and outward flow of the sample into the cavity between the two parallel windows. In UV/VIS and Raman spectroscopy a cuvette may be used with a fused windows or frit sealed window which can be glass to glass seals or fused silica to fused silica seals or a combination of glass and fused silica such as fused silica windows coupled with glass sides, again with opposed windows configured roughly parallel to each other between which there is a sample holding space. This space typically requires a precise thickness known as the “path length” which dictates the thickness the sample contained with the cell. An infrared spectrophotometer projects an infrared beam through the sample for the distance of the path length and infrared energy is absorbed by the vibrational excitation of the molecular bonds of the sample. The path length determines the intensity of the absorbance of the sample under the Beers-Lambert law. The beam continues to a detector in the spectrophotometer where the amount of absorbance is detected by the instrument. Spectral analysis of the sample is either qualitative or quantitative, but all such analysis is based on the intensity of the absorbance and the location within the spectral range of the instrument of the absorbance peaks. Quantitative analysis requires precise path lengths since under Beers Law absorbance is a function of path length. Qualitative analysis (the composition of the constituent parts of a sample) is the study of the intensity of absorbance at a wavenumber of interest which is to say at a specific wavelength in the spectral region of the spectroscopic instrument used in the analysis.

Infrared spectroscopic analysis is extremely sensitive to organic contamination by seals and other spurious absorbance creating molecules. Accordingly, elastomer seals are avoided as they are typically at least somewhat soluble in the types of samples tested in liquid absorbance cells. Although PTFE and other fluorocarbons seals are sometimes used as sealing gaskets, flat gaskets and spacer of comprised of PTFE and similar fluorocarbons do not have good sealing properties. Furthermore, without the use of reinforcing means such as soluble glues, flat PTFE seals cannot withstand much internal pressure without leaking. Accordingly, the practice has been to use inorganic amalgam seals comprised of lead and mercury, neutralized copper and mercury or precious metals. The most common configuration is the lead to mercury amalgam seal, which is used universally in sealed liquid cells for FTIR spectroscopy.

### SUMMARY OF THE INVENTION

This invention comprises a cell for transmission and absorbance testing by means of infrared, UV/VIS or Raman spectroscopy. The invention comprises a unique combination of seals and window configurations which allow use of inert fluoropolymer and/or elastomer seals instead of the convention sealing means used in spectroscopic sampling cells currently is use, particularly lead seals amalgamated with mercury which are not useable under RoHS rules particularly the EU RoHS directive, which is Directive 2011/65/EU of the European Parliament. The seal configuration also permits innovative cell configurations for UV/VIS spectroscopy and Raman which usually employ cuvettes comprised of glass or fused silica with fused seals or melted frit seals.

### DESCRIPTION OF THE FIGURES

FIG. 1 represents a short path absorption cell is used in many different forms for a wide variety of applications in industry and science where analysis of liquids and liquid mixtures is performed by means of spectroscopic analysis.

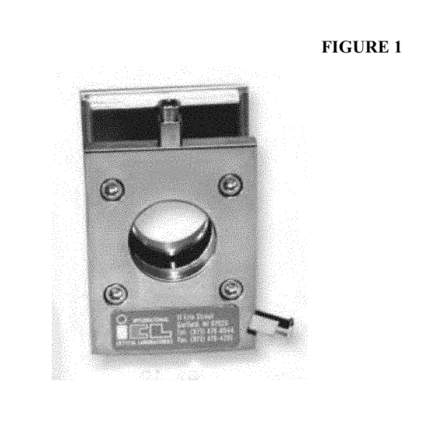

FIG. 2 represents a short path absorption cell having amalgamated seals between two windows of the same size or they require the use of expensive windows such as step windows which enable seals without amalgams but require a combination of expensive and difficult to produce windows (including the step window) coupled with expensive hardware configurations.

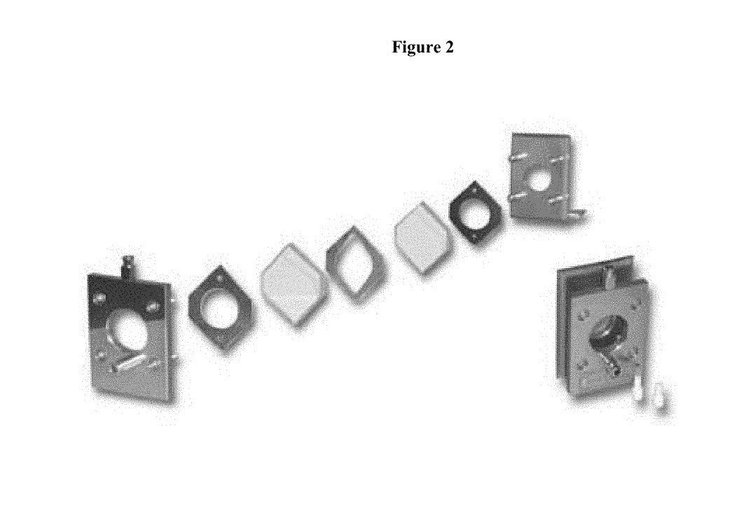

FIG. 3 represents a liquid sample absorbance cell according to the present invention which simplifies cell assembly and calibration and enables the cell to withstand a significant amount of internal pressure or force while at the same time providing an RoHS compliant design because amalgamated seals comprised of lead and mercury are eliminated. It contains two main cell windows, separated only by a thin spacer gasket, in this configuration of the invention, made of PTFE.

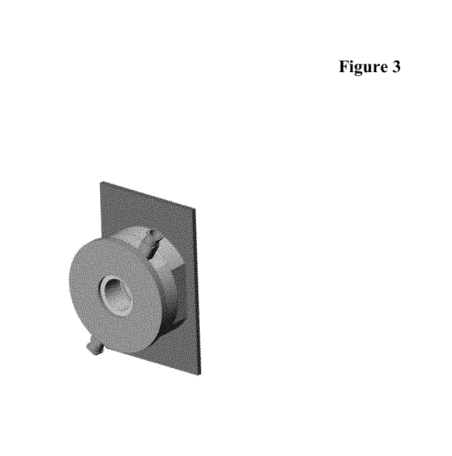

FIG. 4 represents a cell design according to the present invention enabling elimination of the spacer between the 2 windows in another configuration of the invention, since the external seals are sufficient to seal the cell and since path length calibration can be done using the instrument and fringing. Holes in the window allow sample to flow from the top fitting down a pathway into the gap between the windows and out the bottom fitting eliminating the amalgamated seals.

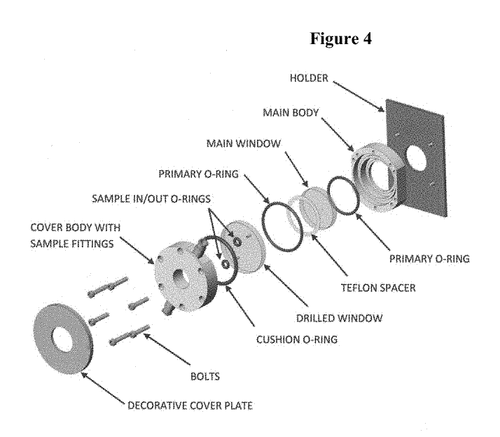

FIG. 5 represents a cell that eliminates the amalgamated seal by the implementation of an innovative double-step “O”-ring groove on the main cell body, a design made possible by using windows of two different diameters, rather than the traditional same-diameter approach.

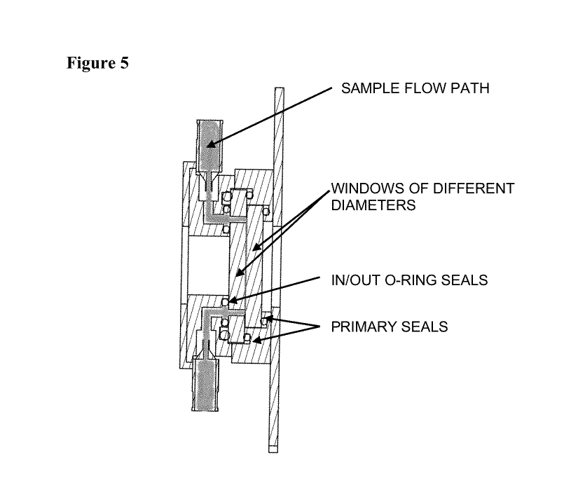

### DETAILED DESCRIPTION OF THE INVENTION

Nearly every version of the sealed liquid cell provided by any number of manufacturers worldwide uses amalgamated seals between two windows of the same size or they require the use of expensive windows such as step windows which enable seals without amalgams but require a combination of expensive and difficult to produce windows (including the step window) coupled with expensive hardware configurations. In order to enhance the seal and more permanently affix the sealed windows in place, epoxy or another is sometimes added to the outer diameter outside of the optical path, which is a messy and inexact approach to sealing the cell and tends to create path length changes as the glue cures. A typical sealed liquid cell using lead spacers and gaskets, the SL-4 manufactured by International Crystal Laboratories, is shown above in exploded view.

This invention is a unique and previously unknown configuration of the liquid sample absorbance cell, which simplifies cell assembly and calibration and enables the cell to withstand a significant amount of internal pressure or force while at the same time providing an RoHS compliant design because amalgamated seals comprised of lead and mercury are eliminated.

The invention is similar to other common versions of the sealed liquid cell only in that it contains two main cell windows, separated only by a thin spacer gasket, in this configuration of the invention, made of PTFE. The cell design enables elimination of the spacer between the 2 windows in another configuration of the invention, since the external seals are sufficient to seal the cell and since path length calibration can be done using the instrument and fringing.

Holes in the window allow sample to flow from the top fitting down a pathway into the gap between the windows and out the bottom fitting. The main design objective for the new invention was to eliminate the amalgamated seals, often made with RoHS non-compliant materials in the amalgam such as lead or mercury. Directive 2011/65/EU of the European Parliament (herein the “RoHS Directive”) because forbids use of any of the materials listed in Annex II as referenced in Article 4 of the RoHS Directive and those materials include lead and mercury. In order to provide a sealing configuration that contains no RoHS non-compliant materials such as lead or mercury, the seal is replaced by on an innovative “O”-ring grouping previously not available. Using “O”-rings in these configurations instead of amalgamated seals is an entirely new and novel invention which takes advantage of the range of crush limits of commercial “O” rings.

The invention comprises a cell that achieves the design objective of eliminating the amalgamated seal by the implementation of an innovative double-step “O”-ring groove on the main cell body, a design made possible by using windows of two different diameters, rather than the traditional same-diameter approach.

Therefore, with the primary O-ring seals double-stepped into the main cell body the spacer can act just as a spacer, and the seal is made with the O-rings alone, eliminating the need for an amalgamated seal. With the new design, any leakage around the spacer is contained by the O-rings. Consequently, assembly and service of the cell is greatly simplified, and at the same time, the O-ring seals in place of the amalgamated seals provide a higher level of sealing performance, from high vacuum to high pressure, all with a single design.

Furthermore, the variance allowed in the O-ring crush specification allows any number of different sized spacers to be used with a single version of the hardware, from 0.025 mm to 0.25 mm and any steps in between. In another configuration of the invention, one or more of the “O” rings seals the external diameter of one or more of the windows such that the O ring is not on the flat face of the optic but on the outer circumference thereof. In this configuration, the spacer can be eliminated.

1. A sealed liquid cell comprising two main cell windows separated by a thin spacer gasket formed of PTFE having no spacer between the two cell windows wherein the external seals are sufficient to seal the cell and wherein the path length calibration can be performed using the instrument and fringing.
